(19) United States
(12) Patent Application Publication
(10) Pub. No.: US 2010/0264063 A1
(43) Pub. Date: Oct. 21, 2010

(54) Bitumen Supply and Grading Method and Apparatus

(75) Inventor: John Morris Vercoe, Tauranga (NZ)

Correspondence Address: ARNOLD & KNOBLOCH, L.L.P., 4900 Woodway Dr., Suite 900, HOUSTON, TX, 77056, US

(73) Assignee: Downer EDI Works Limited, Mount Maunganui (NZ)

(21) Appl. No.: 12/740,997

(22) PCT Filed: Oct. 31, 2008
(86) PCT No.: PCT/NZ08/00290

§ 371 Date: Jun. 23, 2010

(30) Foreign Application Priority Data
Oct. 31, 2007 (NZ) 563033
Dec. 20, 2007 (NZ) 564709

(51) Int. Cl. C10C 3/02; B01J 19/00

(52) U.S. Cl. 208/44; 422/224

(57) ABSTRACT

A method of supplying or producing a desired bitumen grade for application at a site comprising: receiving a single grade of bitumen at/or proximate a bitumen grading facility 20, modifying the bitumen to a desired grade using a cutting or hardening process.

### FIELD OF THE INVENTION

The present invention relates to an improved bitumen distribution method.

### BACKGROUND OF THE INVENTION

It is common for differing grades of bitumen to be manufactured by various methods within the confines of a refinery or blending facility linked to a refinery. These grades are commonly produced by the blending of a hard grade of bitumen with a soft grade of bitumen to produce intermediate (desired) bitumen grades of the correct specification as desired or specified by the user.

This bitumen grade blending normally takes place within (or adjacent to) the refinery or alternatively at a bitumen port plant facility following shipment of the respective grades from the refinery.

With all of the above commonly used processes, it is necessary to transport more than one grade of bitumen down the entire supply chain from the refinery to the end user. Currently, the bitumen grades which are transported to the end-user (or to an intermediary point in the supply chain) are normally a hard grade and a soft grade of bitumen. This is to allow the required intermediary (desired) grades to be produced by blending varying quantities of the soft and hard bitumen grades. This process requires both a hard grade and soft grade to be supplied from the refinery and be on hand. There are normally negative economic implications from having to acquire a variety of both hard and soft grades of bitumen and store them.

For example, one of the difficulties of individual grades being delivered from the refinery or port plant gate is that separate transport and tankage is required to deliver and house the individual grades on-site at the end user's facility.

Often bitumen is purchased overseas as separate grades and blended at the bitumen port plant. The port plant still requires more than one bitumen grade to allow the blending of the full range of required bitumen grades.

As a plurality of grades are required to be transported, stored and handled down the supply chain, the costs are increased by the number of grades which need to be transported. For example, if two grades of bitumen need to transported from the refinery to the port plant or to the end-user, then the delivery and handling costs will be approximately twice that of the case, where a single grade is needed to be transported.

### SUMMARY OF THE INVENTION

It is an object of the present invention to provide an improved bitumen distribution method. This can be achieved through a plant according to an embodiment of the invention.

In one aspect the present invention may be said to consist in a method of supplying or producing a desired bitumen grade for application at a site comprising:
receiving a single grade of bitumen at/or proximate a bitumen grading facility,
modifying the bitumen to a desired grade using a cutting or hardening process.

Preferably the grading facility is at or proximate a point of application.

In another aspect the present invention may be said to consist in a method of supplying or producing a plurality of bitumen grades comprising the steps of:
receiving or supplying a single base grade of bitumen at/to near/proximate a grading facility, wherein the grading facility comprises a plant adapted to produce a different grade of bitumen from the single base grade with cutting oils and/or reactive reagents.

In one aspect the present invention may be said to consist in a method of supplying or producing a plurality of bitumen grades comprising the steps of:
supplying a single grade of bitumen to said end user; and
supplying a bitumen mixing plant to allow said end user to mix the supplied single grade of bitumen with suitable cutting oils and/or reactive reagents to achieve the desired grade of bitumen.

In one aspect the present invention may be said to consist in a bitumen grading plant comprising:
a first tank, said tank holding a single grade of bitumen;
a plurality of smaller reagent and cutting oil holding tanks; and
a blending unit connected to said first tank and said plurality smaller reagent and cutting oil holding tanks for mixing with the single grade of bitumen to produce a required grade of bitumen.

Preferably the blending unit is controlled by a computer program, wherein the program determines a formulation to produce a desired grade of bitumen based on an available base grade of bitumen.

Preferably the formulation comprises a quantity of additive to modify the base grade of bitumen to the desired grade, wherein program comprises a look-up table, graph and/or relationship to determine the formulation.

Preferably the computer program controls the plant to produce the desired grade of bitumen based on the formulation.

Preferably the blending unit is controlled by a computer program, wherein the said program stores the grade and/or character of bitumen held in said first tank, the quality specifications of the cutting oils and reagents and the said program controls a plurality of valves supplying between said first tank, said plurality smaller reagent and cutting oil holding tanks and said blending unit to produce the desired grade of bitumen.

Preferably said bitumen grading plant is portable, and preferably said bitumen grading plant is housed on a vehicle.

In one aspect the present invention may be said to consist in a method for optimally purchasing a single grade of bitumen for the supply of multiple grades of bitumen, said plurality of grades being manufactured using a bitumen grading plant that mixes said single grade of bitumen with reagent and cutting oil, said method comprising the steps of:
identifying the required grades of bitumen and the volume of each required grade;
for each possible single grade purchase:
   identifying the volume of reagent and cutting oil required to produce the total volume of the required grades, and
   pricing the required purchase of reagent and cutting oils along with the cost of each possible single grade of bitumen; and
identifying the optimal single grade bitumen purchase to minimise the overall cost of producing said required grades of bitumen and the volume of each required grade.

In one aspect the present invention may be said to consist in an apparatus for metering and blending cutting oil and reactive reagent with a base grade of bitumen such that a full range of bitumen grades can be produced comprising:
a static mixer,
a manifold feeding said static mixer, said manifold having a plurality of side ports for the addition of additives; and
each side port having a variable speed pump and flow meter; said pump being controlled in accordance with a desired bitumen grade mix.

Preferably the apparatus comprises a personnel computer in which all blend formulations is stored and raw material properties are inputted such that the correct portions of prime bitumen, cutting oil and reactive reagent are blended to produce the specified bitumen grades.

Preferably said apparatus is housed in a standard shipping container.

Preferably said apparatus is portable.

Preferably said apparatus is mounted on a vehicle.

In one aspect the present invention may be said to consist in a method of supplying a desired grade of bitumen comprising:
determining an optimum base grade of bitumen,
providing that base grade of bitumen to a grading facility, wherein the grading facility comprises a plant adapted to produce a different grade of bitumen from the single base grade with cutting oils and/or reactive reagents.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art

The term “comprising” as used in this specification means “consisting at least in part of”. Related terms such as “comprise” and “comprised” are to be interpreted in the same manner.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting

### BRIEF DESCRIPTION OF THE DRAWINGS

Disclosed embodiments and methods of utilising the invention will be further described, with reference to the accompanying figures, by way of example only and without intending to be limiting, wherein;

FIG. 1 is the existing method for distributing bitumen,

FIG. 2a is a bitumen supply chain and plant for producing bitumen according to one embodiment of the invention,

FIG. 2b is a bitumen supply method according to one embodiment,

FIG. 3 is a schematic diagram of showing an overview of a bitumen plant according to one embodiment,

FIG. 4 is a schematic diagram of showing a bitumen plant according to one embodiment in more detail,

FIG. 5 is a flow chart of a method of producing graded bitumen,

FIGS. 6, 7 are screen shots of a user interface of a computer application for controlling the plant,

FIGS. 8, 9 show graphs indicating relationships for determining grading formulations

### DETAILED DESCRIPTION OF THE INVENTION

The present invention relates to the distribution and manufacture of the various grades of bitumen required by an end-user, and the economic benefits which accrue from moving the manufacture of those individual grades closer to the end-user's facility and/or point of application.

To achieve this, the present invention comprises an apparatus that combines bitumen hardening and softening capability along with control systems to allow the desired addition of either cutting oil or reactive reagent to enable the manufacture of the full range of bitumen grades of the correct specification. This allows a single grade of base bitumen to be used for producing any one of a range of desired grades. It also increases the options for desired bitumens that can be provided, without the need for storing a multitude of different base grades.

The plant allows for the transportation and storage of a single grade of bitumen down the entire supply chain from the refiner right through to the end-user (or any intermediary point within the supply chain). The present invention enables this to occur by allowing the end-user to manufacture any required grade of bitumen on-site, ready for use.

Thus a solution is provided that improves bitumen distribution, and in particular improves bitumen distribution while still enabling bitumen grades of various types to be available the end-user.

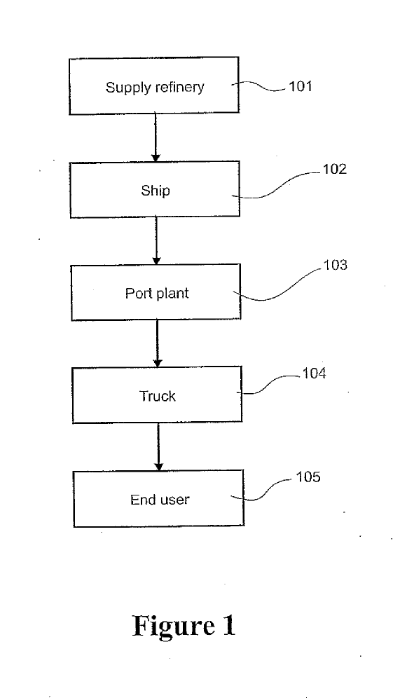

A typical traditional bitumen supply path is illustrated in FIG. 1. The bitumen is supplied, step 101, from the refinery in the required grade, and is shipped, step 102, to a port plant, step 103. The port plant may re-grade the bitumen by receiving multiple grades of bitumen, supplied to the port plant by various refineries. In the port plant 103, the required grades produced from base grades and then are shipped from the port plant, step 104, to the end-user, step 105, for application as required, typically by truck.

The steps outlined above traditionally entail the handling of at least two grades of bitumen and often more than two grades throughout the entire bitumen supply path. This means that separate compartments in the case of shipping or trucking and separate tankage for the individual grades at the supplying refinery, port plant and end user's facility are required.

### Overview of Present Invention

The present invention simplifies the supply chain path of bitumen in comparison to traditional methods, such as that shown in FIG. 1. The present invention relates to a method of producing and/or supplying differing grades of bitumen and the associated supply chain, the apparatus for preparing different grades of bitumen, and a method of preparing bitumen.

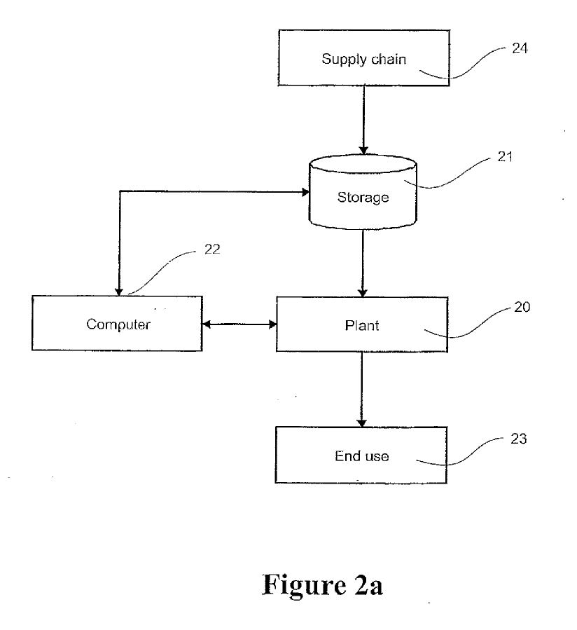

FIG. 2a shows in block diagram form an overview of the present invention. A plant 20 (bitumen grading facility) is provided that takes bitumen and grading components (additives) as input, and manufactures and outputs a bitumen product of the desired grade. The bitumen can then be supplied to the point of application for use. The plant will be typically on site at the point of application, or near to that site.

The plant 20 obtains the base bitumen from a storage facility 21 near (or forming part of) the plant. The storage 21 facility also comprises storage for additives. A computer system 22 in communication with the plant 20 and storage facility 21 controls supply of the bitumen and additives to the plant and controls operation of the plant to create output bitumen of the desired grade. The bitumen in the storage facility 21 is provided via a supply chain 24. This could comprise a traditional supply chain whereby a truck and/or shipping and/or other transportation method retrieves base bitumen from a refinery and provides it to the storage facility 21 for storage.

The plant 20 is adapted to produce a range of bitumen grades from a single base grade of bitumen. This enables simplification of the softening/hardening process, as only one grade of bitumen need be supplied to the storage facility 21 for use by the plant 20. There is no requirement to provide multiple base grades of bitumen for storage and subsequent blending to produce the desired grade. The use of a single grade simplifies the supply logistics, and the storage requirements. This in turn provides efficiencies in producing and providing a desired grade of bitumen.

FIG. 2b shows a method of supplying base grade bitumen and desired grade bitumens according to a preferred embodiment, for example as shown in FIG. 2a. The base bitumen grade used by the plant is transported from a refinery or other repository to the storage facility 21, step 30. This is supplied through a standard logistics supply chain—for example through trucking and/or shipping. The supply of base grade bitumen to the storage facility occurs periodically as in when required, for example when storage tanks become low, step 31. This ensures that the base grade bitumen is available for producing the desired grade of bitumen, step 32, as required and on demand at the point of application.

At or near the point of application, the plant is operated by the computer system 22 (For example, see FIG. 2a) to generate the desired grade of bitumen on demand from the base grade of bitumen in the storage facility 21. The computer system can run various optimisation programs in order to determine the best manner in which to do this based on costs, available materials and other factors. As bitumen of the desired grade is manufactured, it can then be supplied to the point of application, which typically will be nearby. This can occur by the bitumen being piped directly into the end-user's facility. For example, the plant might be portable on a truck or similar. As base grade bitumen is used in the production of desired grade bitumen, the stock of base grade bitumen can be replenished through the supply chain steps 31, 30.

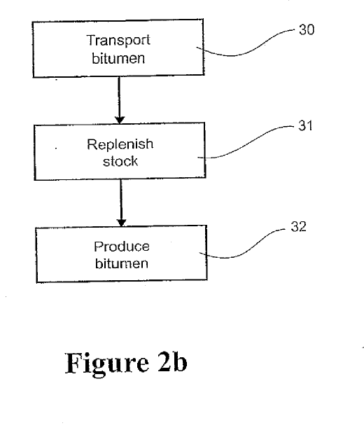

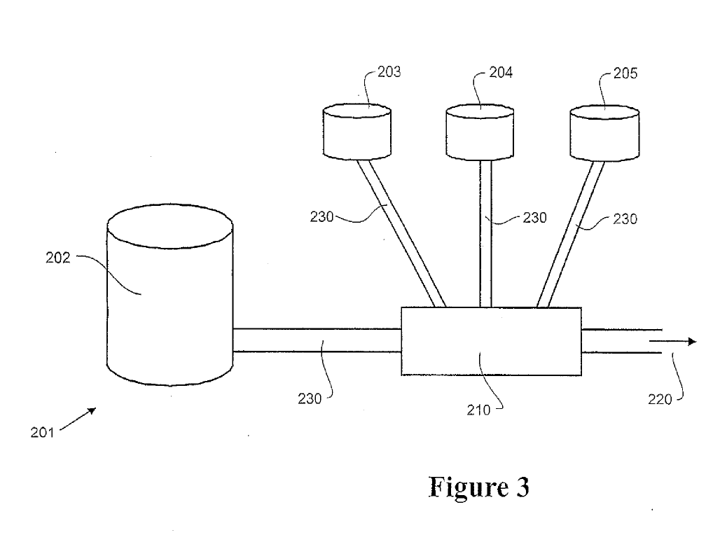

The manufacturing of different bitumen grades at/or near the point of application (e.g. end-user's site) from a single base grade bitumen enables the improved bitumen distribution method of the present invention. The manufacture of the differing bitumen grades at/or near the point of application can be achieved by the embodiment of the plant shown in FIGS. 3, 4. FIG. 3 shows a schematic version of one embodiment of the plant, and FIG. 4 shows one embodiment of the plant in further detail.

The plant (which can be the same as plant 20 in FIG. 2a) produces the desired bitumen grade by modifying (hardening or softening) a base bitumen grade with the use of cutting oils and reactive reagents. This process can alter the grade of bitumen rapidly and in a controlled manner. The use of cutting oils and reactive reagents allows bitumen grade changes to take place immediately before use. Preferably the plant is portable, or quasi-portable, although this is not essential.

The one stored base grade of bitumen can be softened to produce softer desired bitumen grades by metering in the correct quantity of either a mineral oil (e.g. a refinery produced aromatic oil) or vegetable oil (e.g. soyabean oil) of suitable viscosity or such other oil as may be deemed suitable.

The one stored base grade of bitumen can be hardened by reacting the bitumen with an inorganic acid, (such as polyphosphoric acid or related reagent), which alters the molecular make-up of the bitumen producing a desired harder grade of bitumen.

An overview of an example plant 201 to modify the bitumen grade at/or near the point of application (e.g. end user's site) is illustrated in FIG. 3. The plant can be considered to comprise the bitumen storage facility, or the storage facility can be considered separate and coupled to the plant. Preferably the plant and storage facility are located conveniently to each other. The remaining description proceeds on the basis that the plant and storage facility are co-located and form a single plant, although those skilled in the art will appreciate this is not essential. The plant can be portable and placed on a truck or similar. It is envisaged in one embodiment that the bitumen grade modifying plant could be housed on a mobile transporter, allowing for all grades of bitumen to be delivered from one original grade of bitumen held in the transporter's tank (storage facility). In one embodiment the bitumen modifying plant 201 is housed at the port plant facility and to replace the traditional bitumen blending process.

The storage facility 21 of the plant comprises a large base bitumen storage tank 202, and two (or three) reagent and cutting oil holding tanks 203, 204, 205. The storage tanks are coupled to a blending unit 210, wherein pipes 230 and valves connect the bitumen tank 202 and the smaller reagent tanks 203, 204, 205 to the blending unit 210. The reagents/cutting oils can be supplied to the blending unit 210 along with base grade bitumen, where they are mixed to produce the desired grade bitumen. This is done prior to use of the desired grade bitumen in various conventional bitumen industry processes 220 such as asphalt manufacture, bitumen emulsion manufacture or cutback manufacture.

As described earlier, a computer system controls the plant, including the blending unit and storage facility. The valves in the pipes are controlled by the computer system, which is programmed to mix the correct blends for the desired bitumen grade, minimising the skill required of a human operator. The computer would take the measured properties from the laboratory on the characteristics of each of the base bitumen, oil and reagent components and blend the relative amounts in accordance with the program and the laboratory inputs to produce on-specification bitumen products.

### DETAILED DESCRIPTION

The invention will be described in further detail with respect to FIGS. 4 to 9.

### Plant

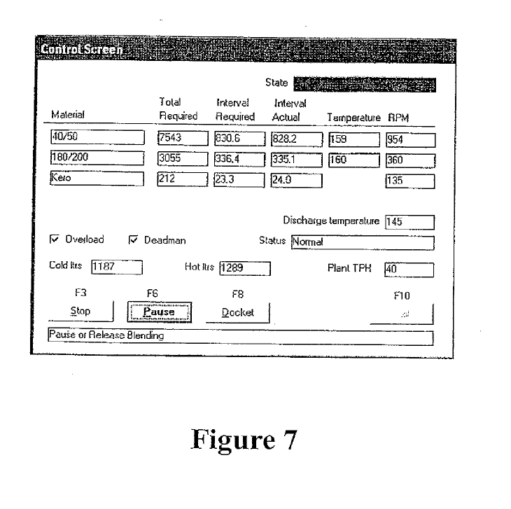

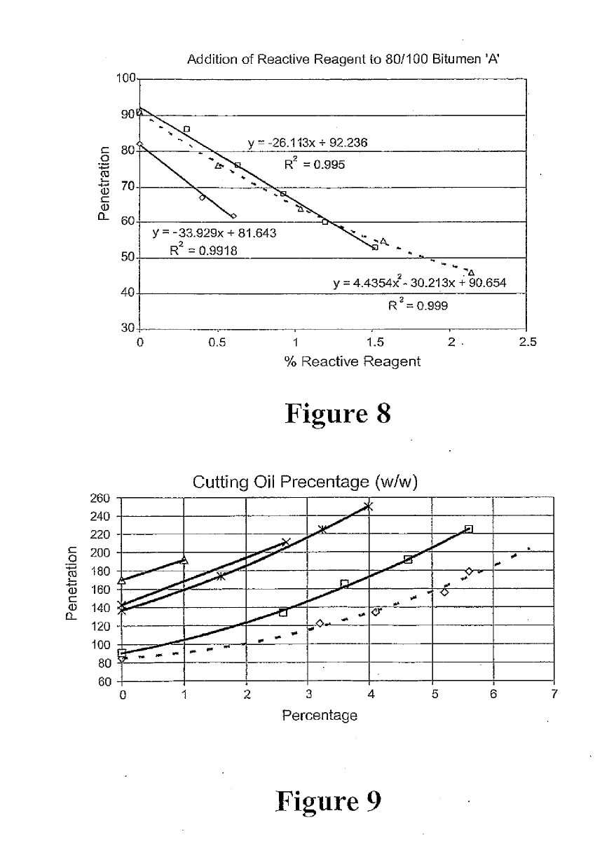

FIG. 4 shows a possible embodiment of the bitumen plant of the present invention in more detail. In general terms, the plant is adapted to modify a selected base grade of bitumen with either cutting oil or reactive reagent to produce a harder or softer desired bitumen grade. This is termed the “reactive/cutting path” method of bitumen manufacture. Reactive reagent/cutting oil quantity look-up tables/graphs are provided (For example, see FIGS. 8, 9). From this, software will calculate the quantity of reagent or cutting oil required to produce a desired bitumen grade. These reactive reagent/cutting oil formulations are calculated and verified in the laboratory for each base bitumen.

Although the software can be considered as a standalone process, in many of the applications of the current invention, it would be incorporated into the controlling software of a related asphalt or emulsion manufacturing plant/computer system. A request from the asphalt plant or emulsion plant for a desired grade of bitumen would activate the reactive reagent/cutting oil software to produce that bitumen immediately on demand. In this way, the ultimate benefits of the current invention would be realised.

By way of example, below is a calculation of the quantity of reactive reagent used to modify a unique delivery of base bitumen from one refinery.

Addition of Reactive Reagent to 80/100 Bitumen ‘A’
Base Bitumen ‘A’ + Reagent

| % | Pen |
|---|---|
| 0 | 91 |
| 0.5 | 76 |
| 1.0 | 64 |
| 1.6 | 55 |
| 2.1 | 46 |

More particularly, the plant works as follows. Base grade bitumen is drawn into the plant by pump 2 from a tank (not illustrated). The pump 2 is a variable speed pump and the pump speed is controlled by the meter 3.

The base grade bitumen passes through the manifold 6, to a static mixer 7 where it is mixed with reagent/cutting oil to modify the base bitumen to the desired grade. The modified (desired grade bitumen) exits the apparatus through flow meter 8 and subsequently into storage or directly into a bitumen utilising process such as an asphalt plant or bitumen emulsion plant.

Heating and insulation 4 extends from Valve 1 through to flow meter 8. This is to allow for preheating of this section of the apparatus and to ensure bitumen flows freely through the apparatus.

At manifold 6, additives can be introduced into the process in a controlled manner using variable speed pumps 10, 14 and 18. These additives can comprise reagents for hardening bitumen and cutting oil for softening bitumen, but may also be liquid polymers or other desired reagents for example kerosene or adhesion agents. While the manifold 6 is illustrated with 4 side ports, as long as 2 ports or inputs are available the manifold may have any number of inputs. Two ports are for introducing cutting oil and reactive agents into the manifold for softening/hardening the bitumen. Other optional ports can be for introducing polymers (for changing the bitumen elasticity and/or other characteristics), adhesion agents (to adhere to aggregate) and/or Kerosene (or other thinning solvents) for temporarily thinning the bitumen to assist application. Flow meters 11, 15 and 19 monitor the rate of flow of these additives and adjust the speed of pumps 10, 14 and 18 accordingly.

The base grade bitumen and the additives are mixed in mixer 7 and the modified grade bitumen exits the apparatus through flow meter 8 into storage (or directly into final use).

Non-return valves 5, 12, 16 and 20 are provided to ensure no back-feeding of additives or bitumen can occur.

Valve 1 is provided to isolate the apparatus from the bulk supply storage of the base bitumen grade.

Further valves 9, 13 and 17 are used to isolate the apparatus from the respective cutting oil/reactive reagent (additive) storage vessels.

A flow meter 8 is provided to measure and record the total quantity of modified grade bitumen exiting the process.

Flow meter 8 provides feedback into the process control for checking the total volume produced.

It acts as a master controller to verify that all input control systems are operating correctly and can also be used as a certified flow meter for customer invoicing purposes.

### Computer Operated Process

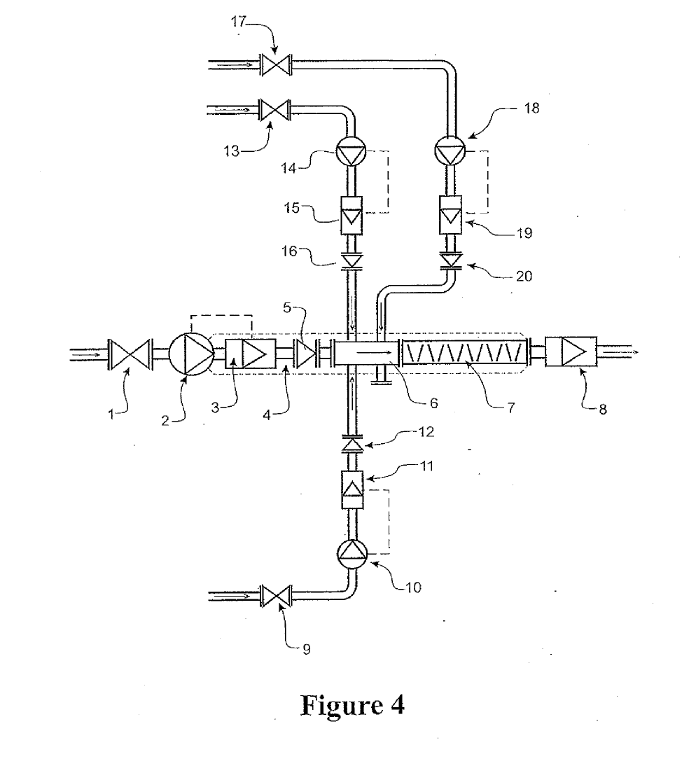

FIGS. 5 to 9 illustrate a method for producing bitumen of a desired grade using a computer to control the plant.

Referring to FIG. 5, the production method is described. To implement the method, the plant is controlled by a programmable logical controller (PLC) interfaced to a standard personal computer (PC). The apparatus could be controlled using a PC work station, or similar.

First, step 50, the computer receives initial inputs to be used in producing bitumen. These inputs could preferably comprise some or all of:
laboratory developed reactive and cutting relationships for the particular base bitumen,
user input for indicating the desired bitumen grade,
quantity and type of base grade bitumen available,
quantity of additives (cutting oil/reagent) available.
other inputs could be received also, where necessary.

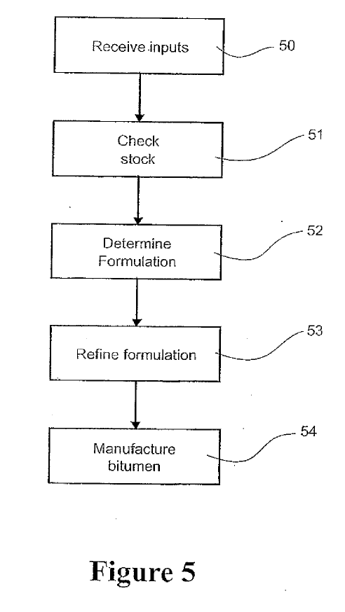

Next, the computer checks available stock of bitumen and additives, step 51, and then determines from those, step 52, the optimum manner in which to produce the desired grade of bitumen. This might use optimisation techniques, and take into account various factors such as availability, economics and the like. A user can adjust or override the computer determined method, if desired. Once the method/formulation for producing the desired grade bitumen has been finalised, step 53, the manufacture of the desired grade bitumen is undertaken by the plant, step 54. This is done under computer control in accordance with the method determined. In step 51, the operator inputs the desired bitumen grade into a user interface 60, such as that shown in FIG. 6. The operator first indicates the desired bitumen grade and the required volume, as shown in fields 61a, 61b. The operator then selects whether the product is required in a transporter or a storage tank. The operator also can select the mode of production. The plant and computer can be operated to produce the desired grade using blending of several bitumen grades (blending process). Alternatively, they can select method according the preferred embodiment of using a reactive reagent/cutting oil process (oil/cat process), as appropriate, to get the desired grade.

The computer then determines a formulation or “recipe” for producing the desired quantity/grade of bitumen, using its knowledge of the available resources. The are a number of alternative ways to determine the formulation.

In one embodiment, the computer program could simply select the available base grade bitumen grade. It will then determine the quantity required to achieve the desired grade bitumen quantity. It would then determine if the base grade needs to be hardened or softened to achieve the desired grade. If hardening is required, then the computer program will determine that a quantity of reactive reagent will be needed. If softening is required, then the computer program will determine that a quantity of cutting oil will be needed.

To determine the quantity of reactive reagent/cutting oil (additive) required, the computer program can use look-up tables, algorithms, equations or similar. The quantity of additive will be dependent on the quantity of base grade bitumen being used, and desired quantity and grade of the modified bitumen. Relationships/graphs such as that shown in FIGS. 8 and 9 could be used to determine the reactive agent/cutting oil quantities.

For example, FIG. 8 shows a graph of indicating the mathematical relationship between bitumen grade and reactive reagent to achieve a desired bitumen grade. Here penetration refers to refers to the hardness of the bitumen and is directly related the bitumen grade. Three mathematical relationships are graphed, each relating to a base bitumen grade, and how the grade is altered based on a percentage of reagent added. The solid lines refer to Singapore bitumen of around penetration 91 and 82 respectively. The dotted line refers to US sourced bitumen, at a penetration of around 91. This illustrates that similar grades from different sources might require different formulations for softening. The mathematical relationships are:

Base grade #1(Singapore 82):Y=−33.929x+81.643, R²=0.9918

Base grade #2(Singapore 91):Y=−26.113x+92.236, R²=0.995

Base grade #3(US 91):Y=4.4345x²−30.213x+90.654, R²=0.999
where Y is the penetration, x is the percentage of reactive reagent and R is the confidence of the line fit.

The unmodified (base) bitumen grade is shown where the relationships cross the y axis. By using such a relationship for the chosen base grade of bitumen, the quantity of reagent required to achieve the desired grade of bitumen can be determined. It will be appreciated that a large number of such relationships could be stored, all relating to different base bitumen grades that might be on hand. It will also be appreciated, that for a particular base bitumen grade, there might be different sources of that bitumen. Therefore, the relationships might be different for bitumens of the same base grade, but from different sources, as can be seen for two different 80/100 base bitumens shown by the solid line commencing at 92 penetration.

Similar, FIG. 9 shows a graph of indicating the mathematical relationships between bitumen grade and cutting oil percentage to achieve a desired bitumen grade. Here, penetration refers to the hardness of the bitumen and is directly related to the bitumen grade. There are five bitumens shown. The dotted line relates to a US sourced bitumen of penetration around 85. The remaining solid lines relate to Singapore sourced bitumen with penetrations (grades) between around 90 and 170. Five mathematical relationships are graphed, each relating to a base bitumen grade, and how the grade is altered based on a percentage of cutting oil added. The unmodified (base) bitumen grade is shown where the relationships cross the y axis. By using such a relationship for the chosen base grade of bitumen, the quantity of cutting required to achieve the desired grade of bitumen can be determined. It will be appreciated that a large number of such relationships could be stored, all relating to different base bitumen grades from differing sources and/or refineries that might be on hand. It will also be appreciated, that for a particular base bitumen grade, there might be different sources of that bitumen. Therefore, the relationships might be different for bitumens of the same base grade, but from different sources/refineries, as can be seen for two different 80/100 base bitumens shown by the solid line commencing at approximately 90 penetration and the dotted line commencing at approximately 85 penetration.

Once the cutting oil/reagent quantity is determined, the computer program will have a proposed formulation for manufacturing the desired grade of bitumen. Examples of formulations are:
Starting with base grade 80/100 bitumen and adding 1% acid (reagent) would result in a desired 60/70 penetration (grade) bitumen.
Starting with base grade 80/100 bitumen and adding 2.2% acid (reagent) would result a desired 40/50 (grade) penetration bitumen
Starting with base grade 80/100 bitumen and adding 2.7% oil would result in a desired 130/150 (grade) penetration bitumen
Starting with base grade 80/100 bitumen and adding 4.6% oil would result in a desired 180/200 (grade) penetration bitumen.

The computer displays this information on the user interface 60. Namely, it displays the based and desired grades of bitumen, the reagent/cutting oil to be added, and the respective quantities. This can be adjusted by the operator, if they see reason to.

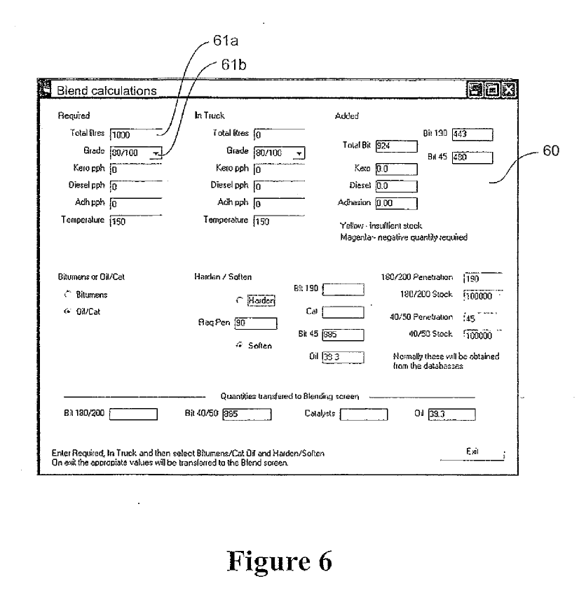

Once the operator is satisfied with the formulation, a further user interface is displayed, as shown in FIG. 7. This display details of:
the quantity of base bitumen required,
the quantity of reactive reagent or cutting oil required (for the reactive/cutting path” option.),
temperatures, and
any other information of relevance.

The operator can the initiate the plant (via the computer) to commence production of the desired grade bitumen in accordance with the formulation.

Initiation occurs by the operator pressing the start button so that the computer takes control of the plant, including starting and setting the speed of all pumps. During production, the formulation percentages will be controlled by the computer, this control being achieved by the flow meters communicating with the variable speed drives of their respective pumps. The flow meters have the ability to constantly adjust the speed of the pumps, thereby controlling the relative amount of the various components. Alarms will be raised to warn the operator if any additive goes outside a preset tolerance. At the conclusion of production the plant would go through the PLC controlled shutdown sequence and stop.

In alternative embodiments, a range of base grade bitumens might be available for use in generating desired grade bitumen. This might occur, for example, where there is blending capability in the plant. In this case, optimisation can take place to determine the best manner in which to generate the desired bitumen grade, from available base grades and cutting oils/reactive reagents. This optimisation could take into account economic, supply and other factors.

For example, where a particular desired grade is required, the computer program might have the choice of two starting base grades, of which it must select one. It might just simply select the base grade closest to the desired grade. However, this might not achieve the cost optimal solution. If a base grade “further” from the desired grade is cheaper, it might be cheaper overall to use that as the base grade, even though more reagent/cutting oil might be required.

Alternatively or additionally, where base grades exist either side of the desired grade, a selection might be based on whether it is cheaper to use cutting oil to soften the harder base grade, or reagents to harden the softer base grade

Alternatively or additionally, supply issues might also be considered. For example, a preferred base grade might exist but is in short supply. It might be decided that another less preferred base grade be used, as it is more plentiful in stock.

Suitable optimisation methods could be used to determine the best formulation. For example, the following could be considered:
availability of base grade bitumens,
cost of base grade bitumens per volume versus cost of reactive reagents/cutting oils per volume,
volume of desired grade bitumen required.

These are the types of equations that might be used for optimisation

Desired grade=base grade+constant*additive percentage

Cost=Bitumen cost*quantity+additive cost*quantity

Quantity(desired)required=x*base grade quantity+(1−x)*additive quantity, where 0<=x<=1

Where only one grade of bitumen is being stored, the present invention also allows for optimisation to determine which grade of bitumen that should be.

For example, an end user might use 5 different grades of bitumen for the point of application. They would also know the quantities of each of these typically used. They will also have access to different grades of base bitumen, from different sources.

Using optimisation, the end user can determine the best single base grade of bitumen to use, based on:
desired grades to be produced, and the typical quantities required,
availability and costs of base grades,
quantities and costs of additives to produce desired base grades from each of the available base grades.

Optimisation might be based on cost. That is, taking into account all the factors, what is the best base grade to stock, that will minimise the cost for the desired grades required? Linear programming or similar could be used for this. The method can then involve determining the optimum grade, and receiving that grade at the plant.

### Details of the Chemical Hardening and Oil Cutting Softening Process

As noted earlier, if the base grade bitumen requires hardening to achieve the desired grade, then a reactive reagent hardening process is undertaken using a reactive reagent.

The chemical modification of bitumen is achieved through the use of Polyphosphoric Acid (PPA). The chemical modification of bitumen with PPA is sometimes loosely referred to as a catalytic process, although technically it is not. Fundamentally a catalyst is not changed or consumed during the reaction, whereas PPA is consumed during its reaction with bitumen.

The PPA acts as a de-agglomerant of the asphaltenes present in bitumen. A fraction of the added PPA also reacts with the basic sites of asphaltenes, this leading to an increase in the asphaltene (+resin) content. This in turn increases the structure of the bitumen, thereby producing a harder grade of bitumen. The reaction between PPA and bitumen is almost instantaneous and appears to be non-reversible.

The property of the resultant bitumen obtained from reaction of the PPA with a base bitumen does depend on the chemical nature of the base bitumen. For example, Mexican or Venezuelan crude based bitumens are much more reactive and require less PPA reagent to achieve a particular end grade, than for example Middle Eastern crude based bitumen. This reactivity can be determined through experimentation. For example, each new base bitumen used in the PPA process can be tested in the laboratory using varying concentrations of PPA acid to determine the “blending ratios” to produce each end grade of desired bitumen.

The quantity of PPA required to produce harder and harder grades of bitumen increases exponentially. For example it requires 1.03% (w/w) of PPA to modify a 80/100 Middle Eastern based bitumen to 60/70 penetration grade, but 2.19% (w/w) of PPA to produce a 40/50 grade. This fact normally limits how low a penetration base grade can economically be produced.

As noted earlier, if the base grade bitumen requires softening to achieve the desired grade, then a thinning process is undertaken using cutting oil.

There are two main oils that can be used in the process, they are:
Mineral Oils (ex refinery) e.g. OTEC 516 ex Australia.
Soyabean Oil (renewable resource) ex Argentina.

The cutting oils are blended into the bitumen via a static mixer. Unlike the PPA addition and reaction, there is no chemical reaction between the bitumen and the cutting oil, the action is purely thinning of the bitumen by dilution with a light oil. The nature of the cutting oil is important if the desired long-term softening of the produced bitumen grade is to be maintained.

As with the PPA, the quantity of cutting oil required does varying with differing bitumens. The quantities of reactive reagent required to obtain a desired penetration value depend on the chemical characteristics of the base bitumen. Therefore, for every new bitumen source, laboratory tests are undertaken to determine the quantity of cutting oil required to produce each desired grade of bitumen. This process is also undertaken for every subsequent shipment/batch of bitumen even though it may come from the same source, as the crude or crude blend which was used in the preparation of the bitumen may change and therefore the chemical nature of the base bitumen could have changed.

These “blend ratios” are then transferred to the blending software, for management of each of the desired bitumen grades. The blend ratios are determined in the laboratory by measurement of bitumen penetration on a range of cutting oil addition concentrations to the base bitumen and then plotting the end bitumen penetrations. Once this graph has been produced the concentration/penetration relationship can be used in the blending software.

Once the “blend ratio” for a particular base bitumen has been loaded into the blending software, the base bitumen is selected from the software recipe, the desired grade of bitumen is selected from the software recipe and the quantity of cutting oil is pumped via the static mixer into the base bitumen stream thereby converting it to the desired grade into the storage tank or transporter. This process can be undertaken via a blending unit mounted directly on the transporter thereby delivering a range of grades of desired bitumen from the one vehicle.

The accuracy of the metering method is important if the grades of bitumen are to meet the required specifications. Careful selection of cutting oil's for volatility is desired to ensure that little oil is lost during subsequent manufacturing methods for both asphalt manufacture and chip-sealing application.

The use of PPA bitumen modification and cutting oil modification within the same unit allows maximum flexibility in the selection of the base bitumen. For example, the starting grade of bitumen could vary for example from a 60/70 penetration grade bitumen to a 80/100 penetration grade bitumen and the full range of desired grades could still be manufactured using either PPA modification or cutting oil addition.

The combined blending unit also has the ability of using various unconventional base grades of bitumen, such as USA specification PG67-22 grade base bitumen and still have the ability to produce conforming New Zealand penetration or Australian viscosity graded bitumens. It would be possible for the blending control system to be integrated with the control system of an emulsion or asphalt plant, such that, if the emulsion plant required a 180/200 grade bitumen to be emulsified, then the blending control system would add the required amount of cutting oil to the base bitumen just prior to the bitumen entering the emulsion plant. Likewise, with the integration into an asphalt plant, the blending unit would add the required amount of PPA to produce the desired hard bitumen grade, just before the bitumen was added to the asphalt mix.

In this way the blending unit provides maximum flexibility of bitumen grade availability for the various processes. That is, either bitumen emulsion manufacture or asphalt manufacture without the need to hold in stock more than one grade of base bitumen.

### Advantages

The present invention provides economic benefits at each stage of the bitumen supply path.

Traditionally, a range of “constituent” grades of bitumen has to be obtained. The grades provide the ability to produce the desired bitumen grade (through blending the constituent grades) for the point of application. The traditional approach requires a range of bitumen grades to be obtained, transported, stored and replenished to ensure all grades are on hand to produce the desired bitumen grades. This creates supply logistics difficulties along with the associated costs.

The present invention entails the handling of only one grade of bitumen. This occurs because the supply system of the present invention moves the manufacture of individual bitumen grades at/or near the end user's facility. The grading of bitumen under the present invention occurs immediately prior to use. This simplifies the supply chain immensely in that only one grade of bitumen is required to be supplied from the supplying refinery, shipping entails only one grade of bitumen being transported, and the port plant only requires tankage (and infrastructure e.g. pumping facilities) for one grade of bitumen. Additionally, all trucking is with one grade of bitumen, thereby minimising any contamination risk. Also, the end user only requires storage for one grade of bitumen, rather than multiple grades (that is, multiple bitumen tanks).

The present invention simplifies the supply logistics, as only one base grade of bitumen is required. This provides economic benefits.

Further, the present invention allows bitumen to be purchased from a greater number of refineries worldwide. Each of these refineries, normally manufacture bitumen to the primary bitumen specification required by their major customers. For example, an American based refinery will manufacture bitumen to an USA bitumen specification. The present invention allows for the purchase of bitumen from a greater number of potential suppliers in varying countries, manufactured to differing specifications and bitumen grades. This provides economic gains due to a greater range of potential suppliers and suitable bitumen's being available.

The present invention envisages the utilisation of a linear program or similar optimisation to determine the economic fit between a plurality of potential bitumen sources and the end user's bitumen requirements. The computer program allows rapid evaluation of whether all the required bitumen grades can be economically manufactured from the potential source of bitumen.

Traditionally when port blending, two grades of bitumen are required, typically the two grades may not be available from the one refinery, and this necessitates two refinery sourcing. The need to load at two separate refineries increases shipping or transportation costs tremendously. The method of the present invention allows for the purchase of one bitumen grade thus two point sourcing is no longer required and significant costs savings result.

Additionally when purchasing two or more grades most refineries consider the purchase a “special” case and standard pricing does not apply. When purchasing only one grade the pricing for those standard readily available local bitumen grades is readily available and the transaction is simpler to conclude.

Significant economic benefits result with single bitumen grade purchase and delivery. With only one grade of bitumen being required there is no need for segregation of bitumen grades on the vessel, this minimises the difficulties in loading and discharge, and speeds up both of these processes thereby reducing the time a vessel is in port and possible demurrage costs.

Documentation and risk of error on loading is minimised and the possible need for two port loading for differing bitumen grades is negated.

Product testing and superintendence costs are related to the number of bitumen grades, the more grades purchased the higher these costs. By shipping and storing only one grade, these costs are reduced. For example, as each grade of bitumen is treated as a separate entity, the sampling and testing requirements (and hence cost) is reduced by half should one grade of bitumen be shipped rather than two.

The present invention also allows the size and capability of port plants to be greatly reduced. The reduction in size and capability reduces capital investment and operating costs related to: heating, maintenance and stockholding at the plants.

The present invention allows delivery of a single grade of bitumen into two markets, which have different bitumen specifications.

The requirement for one tank in which to store one grade of bitumen, rather than multiple tanks provides significant economic benefits to the port facility.

There is a lower capital requirement because of a reduced tankage footprint. That is, the land requirements are smaller. There are reduced operating overheads; including repairs and maintenance, heating, stockholding and reduced tank heels. Tank heels are the part of the tank from which product is not easily able to be drawn under normal operation

Bitumen blowing is one traditional method for manufacturing hard grades of bitumen from softer grades. This method is however energy demanding, expensive and capital intensive, the present invention negates this cost.

With reduced numbers of bitumen grades being required, the risk of running out of one particular grade of bitumen because of unforeseen increased usage of that particular grade is reduced.

The present invention provides an opportunity for efficient truck and trailer utilisation. As there is only one grade of bitumen to be transported to the end-user, the transport can be optimised to maintain the stockholding of bitumen at the end-user's facility. There is no longer the need to maintain sufficient stock of multiple grades at the end-user's facilities. Further there is reduced risk of cross-contamination by differing bitumen grades, as one grade only is being transported by the transport fleet.

The need to maintain stock of only one grade of bitumen increases the opportunity and reduces the cost of installing remote electronic tank level monitoring. This enables the bitumen supply company to remotely monitor bitumen levels at the end user's facility and optimise deliveries accordingly. The use of remote monitoring is made possible because there is no need to know what grade of bitumen is required by the end user in any given timeframe.

The requirement that end-users have multiple tanks is eliminated by the present invention as with only one grade only one tank for storing bitumen is needed. As with the port facility there is a reduced tankage footprint and reduced operating overheads; including repairs and maintenance, heating, stockholding and reduced tank heels.

Additionally, because of sizable storage capital and operational costs, end-users tend to limit the range of bitumen grades they hold on-site and therefore the range of products they are able to use. The present invention removes this restriction and increases the end user's flexibility by providing a means for the end user to manufacture a much greater grade range of products.

The presence of a blending unit, as described above at the end-user's facility allows for the manufacture of “non-standard” bitumen grades. Particular techniques, such as heavy duty asphalt production, require the use of “non-standard” bitumen grades. These bitumen grades are normally much harder than those covered by the standard bitumen specifications. The present invention allows for the production of these non-standard bitumen grades without any increase in tankage, transport or infrastructure, as would normally be the case and also allows manufacture of relatively small volumes without incremental cost.

### Other Embodiments

The plant described could also incorporate the ability to produce desired bitumen grades from multiple sources, using existing blending methods. This would not detract from the present invention. The plant, where suitable, could still be used as a reactive reagent/cutting oil facility, which uses only that capability, despite having the existing blending capability. From this would flow the additional benefit of being able to manufacture using only one grade of bitumen.

The computer could be controlled to operate the plant to produce bitumen using blending, as well as reactive reagent/cutting oil manufacture.

When operated under the blending method, the computer could determine the available base bitumen grades. It could the use formulations/look-up tables/graphs in its software to implement the following. The quantities of base bitumens required to obtain a desired penetration value are calculated via, for example:

$$log ( Desired penetration ) = A \% \times log ( 40 / 50 pen value ) + B \% \times log ( 180 / 200 pen value )$$

$$100 \; 100$$

where A, B are the respective percentages different grades of bitumen making up the desired grade (where B=100−A). Pen value is the penetration.

The above formulation takes the penetration value of the two base bitumens and calculates the quantities of each grade required to produce the penetration value of the final desired bitumen grade.

1. A method of supplying or producing a desired bitumen grade for application at a site comprising:
receiving a single grade of bitumen at/or proximate a bitumen grading facility, modifying the bitumen to a desired grade using a cutting or hardening process.

2. A method according to claim 1 wherein the grading facility is at or proximate a point of application.

3. A method of supplying or producing a plurality of bitumen grades comprising the steps of:
receiving or supplying a single base grade of bitumen at/to near/proximate a grading facility, wherein the grading facility comprises a plant adapted to produce a different grade of bitumen from the single base grade with cutting oils and/or reactive reagents.

4. A method of supplying or producing a plurality of bitumen grades comprising the steps of:
supplying a single grade of bitumen to said end user; and
supplying a bitumen mixing plant to allow said end user to mix the supplied single grade of bitumen with suitable cutting oils and/or reactive reagents to achieve the desired grade of bitumen.

5. A bitumen grading plant comprising:
a first tank, said tank holding a single grade of bitumen;
a plurality of smaller reagent and cutting oil holding tanks; and
a blending unit connected to said first tank and said plurality smaller reagent and cutting oil holding tanks for mixing with the single grade of bitumen to produce a required grade of bitumen.

6. A bitumen grading plant according to claim 5 wherein the blending unit is controlled by a computer program, wherein the program determines a formulation to produce a desired grade of bitumen based on an available base grade of bitumen.

7. A bitumen grading plant according to claim 6 wherein the formulation comprises a quantity of additive to modify the base grade of bitumen to the desired grade, wherein program comprises a look-up table, graph and/or relationship to determine the formulation.

8. A bitumen grading plant according to claim 6 wherein the computer program controls the plant to produce the desired grade of bitumen based on the formulation.

9. A bitumen grading plant according to claim 5 wherein the blending unit is controlled by a computer program, wherein the said program stores the grade and/or character of bitumen held in said first tank, the quality specifications of the cutting oils and reagents and the said program controls a plurality of valves supplying between said first tank, said plurality smaller reagent and cutting oil holding tanks and said blending unit to produce the desired grade of bitumen.

10. A bitumen grading plant according to claim 5 wherein said bitumen grading plant is portable, and preferably said bitumen grading plant is housed on a vehicle.

11. A method for optimally purchasing a single grade of bitumen for the supply of multiple grades of bitumen, said plurality of grades being manufactured using a bitumen grading plant that mixes said single grade of bitumen with reagent and cutting oil, said method comprising the steps of:
identifying the required grades of bitumen and the volume of each required grade;
for each possible single grade purchase:
identifying the volume of reagent and cutting oil required to produce the total volume of the required grades, and
pricing the required purchase of reagent and cutting oils along with the cost of each possible single grade of bitumen; and
identifying the optimal single grade bitumen purchase to minimise the overall cost of producing said required grades of bitumen and the volume of each required grade.

12. An apparatus for metering and blending cutting oil and reactive reagent with a base grade of bitumen such that a full range of bitumen grades can be produced comprising:
a static mixer,
a manifold feeding said static mixer, said manifold having a plurality of side ports for the addition of additives; and
each side port having a variable speed pump and flow meter; said pump being controlled in accordance with a desired bitumen grade mix.

13. An apparatus of claim 12 comprising a personnel computer in which all blend formulations is stored and raw material properties are inputted such that the correct portions of prime bitumen, cutting oil and reactive reagent are blended to produce the specified bitumen grades.

14. An apparatus as claimed in claim 12 wherein said apparatus is housed in a standard shipping container.

15. An apparatus as claimed in claim 12 wherein said apparatus is portable.

16. An apparatus of claim 15 wherein said apparatus is mounted on a vehicle.

17. A method of supplying a desired grade of bitumen comprising:
determining an optimum base grade of bitumen,
providing that base grade of bitumen to a grading facility, wherein the grading facility comprises a plant adapted to produce a different grade of bitumen from the single base grade with cutting oils and/or reactive reagents.

18. (canceled)

19. (canceled)
